(19) United States
(12) Patent Application Publication
(10) Pub. No.: US 2003/0150493 A1
(43) Pub. Date: Aug. 14, 2003

(54) In-line differential pressure controller

(76) Inventor: Walter S. Glover, Rocky Mountain House (CA)

Correspondence Address: Sean W. Goodwin, Goodwin McKay, The Burns Building, 237 - 8th Avenue S.E., Suite 360, Calgary, AB, T2G 5C3, CA

(21) Appl. No.: 10/365,510

(22) Filed: Feb. 13, 2003

Related U.S. Application Data
(60) Provisional application No. 60/356,141, filed on Feb. 14, 2002.

(51) Int. Cl. F16K 15/00

(52) U.S. Cl. 137/515.7

(57) ABSTRACT

A novel apparatus and system for developing a pressure differential in a gas flow line is provided. The apparatus comprises a flange-supported plate having a flow port formed therethrough and a pressure control valve mounted thereon for controlling flow through the port. The valve is positioned inside the gas flow line and the plate is of such dimensions so as to direct substantially all of the line's gas flow through the flow port and valve. The system comprises at least one flanged connection in the gas flow line and the apparatus, as described above, inserted into the line at the flanged connection. In another embodiment the system further comprises a well inlet separator, a gas meter and a liquid level control with a dump line downstream of the gas meter. The flanged connection is located downstream of the well inlet separator and upstream of the dump line.

### CROSS REFERENCE TO RELATED APPLICATION

This application is related to and claims the benefit of a co-pending U.S. Provisional application Ser. No. U.S. 60/356,141, filed on Feb. 14, 2002, the entirety of which is incorporated herein by reference.

### FIELD OF THE INVENTION

The present invention relates to an apparatus and system for developing a pressure differential in a flanged gas flow line. More particularly, a control valve is affixed to a flow plate for installation between flanges, the valve hardware being mounted to the plate and residing in the flow line for generating a pressure differential.

### BACKGROUND OF THE INVENTION

In a pressurized gas/liquid separator system it is sometimes necessary to blow down the liquid from the separation vessel to the same high pressure gas discharge line; such as when removing liquid from a gas stream prior to the gas stream passing through a gas meter. To do so, one requires a pressure differential. One conventional means for developing the necessary pressure differential involves inserting an orifice plate at an appropriate place in the gas flow line; typically in a flanged connection. However, one major disadvantage of an orifice plate is that, as the flow changes, there are associated variations in pressure drop and the upstream pressure. One advantage is that orifice plates are rather inexpensive.

To overcome the problem of pressure variations associated with flow changes through an orifice plate, a diaphragm-actuated back pressure valve is also typically employed in the industry. Kimray, Inc., of Oklahoma City Okla., manufactures such back pressure valves. However, the Kimray valves are limited to systems under 500 psig, require effort to fit, retro-fit or to modify an existing flow line, and are quite expensive.

A control system implementing controls and control valve may be used to create the desired pressure differential without variations in downstream pressure associated with changes in flow. One such control system is a Control Valve such as that manufactured by Fisher Controls International, Inc. which is now a member of the Emerson Process Management, Cedar Rapids, Iowa. However, such a control valve is prohibitively expensive (over ten thousand dollars), requires significant efforts to retro-fit and requires instrument or fuel gas to operate.

All of the above references, therefore, lack one or more necessary elements for successful wide utilization in the industry. That is, these prior art references may be prohibitively expensive, too complicated to install, maintain or operate, have parts subject to failure, be sensitive to changes in flow, or may be difficult to retro-fit into existing gas flow lines.

### SUMMARY OF THE INVENTION

A novel apparatus and system for developing a pressure differential in a gas flow line is provided. The differential pressure controller apparatus comprises a flange-supported plate having at least one flow port formed therethrough and a pressure control valve mounted on the plate for controlling flow through the port. The valve is of such dimensions so as to be positioned inside a gas flow line and the plate is of such dimensions so as to direct substantially all of the line's gas flow through the flow port and valve.

The system comprises at least one flanged connection in the gas flow line and a differential pressure controller, as described above, inserted into the line at the flanged connection. In another embodiment the system further comprises a well inlet separator, a gas meter and a liquid level control with a dump line downstream of the gas meter. The flanged connection is located downstream of the well inlet separator and upstream of the dump line.

### BRIEF DESCRIPTION OF THE DRAWINGS

FIG. 1 is a side view of one embodiment of the invention mounted in a flanged connection of the gas line;

FIG. 2 is a side view of the invention according to FIG. 1 shown with the pressure valve in the open position;

FIG. 3 is a schematic view of a pressurized wellhead separator system illustrating various placement options for the invention; and

FIG. 4 is a schematic view of the invention used to induce sufficient differential pressure to produce a sample stream for a chromatograph, moisture analyzer or other such analyzer.

### DETAILED DESCRIPTION OF THE PREFERRED EMBODIMENT

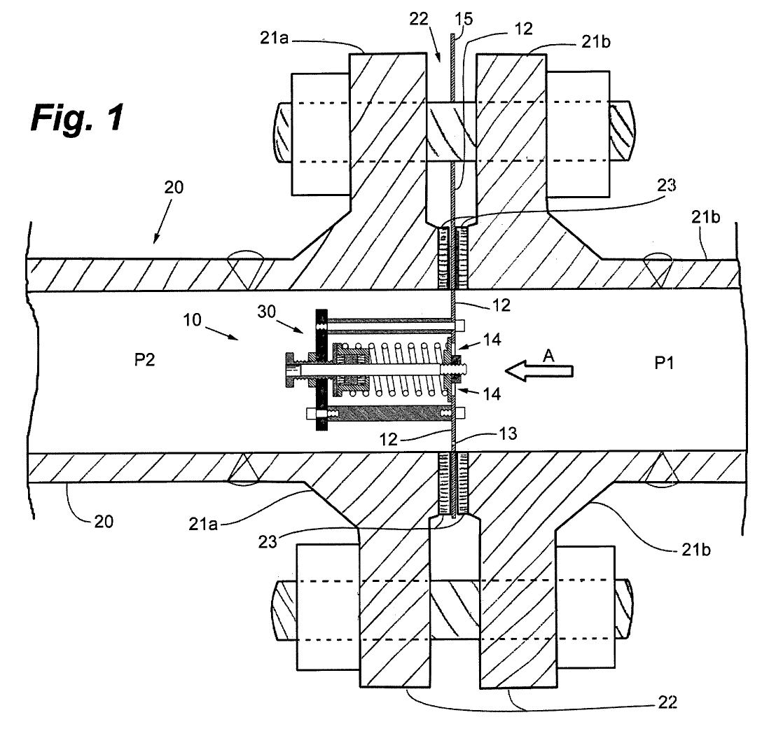

Having reference to FIG. 1, one embodiment of the differential pressure controller 10 is illustrated. Generally, the controller 10 comprises a flange-supported plate 12 having at least one flow port 14 formed therethrough and at least one pressure control valve 30 mounted thereon and adapted to control flow A through the port 14 or ports. The controller 10 is inserted into a flow line 20, at a flanged connection 22 between two flanges 21a, 21b, so as to create a pressure differential from a higher pressure P1 to a lower pressure P2. Typical American Petroleum Institute flanges 21a, 21b are suitable. Preferably, the installation of the controller 10 includes gaskets 23 on each side of the plate 12.

The plate 12 is of such planar dimensions so as to block the flow line 20 and direct substantially all of the gas flow through the port 14 and hence the pressure control valve 30, when the plate 12 is inserted into the line 20 and supported at the flanged connection 22. Preferably, the plate 12 has a small liquid bleed or drain hole 13 to be oriented at the bottom of the pipe. The drain hole 13 permits a relatively insubstantial flow of gas therethrough. However, the hole 13 allows liquid to bleed across, thereby ensuring continued smooth operation of the valve 30. More preferably, the flange-supported plate 12 has an extension or tab 15 which extends beyond the flanged connection. The tab 15 facilitates installation and can display controller information such as the specifications of the valve 30.

The valve 30 is mounted substantially on one side of the plate 12 and controls the gas flow through the port 14. In this embodiment the valve 30 is mounted on the downstream or lower pressure side P2 of the plate 12 and also opens or seals the port 14 on the downstream side P2. However, a valve mounted across the plate 12 or substantially on the upstream or high pressure side P1 of the plate 12 could be equally suitable. More importantly, the pressure control valve 30 is of such dimensions so as to reside wholly within the flow line 20 while supported by the plate 12.

Advantageously, by mounting or supporting the valve 30 from the plate 12, and sizing the valve 30 so as to fit inside the gas flow line 20, the controller 10 can be inserted at a flanged connection 22 without having to modify the structure of an existing flow line 20; as the plate 12 and any additional gaskets 23 are typically sufficiently thin to allow the flanged connection 22 to be reassembled without redesign of the related piping. The controller 10 can directly replace an orifice plate of the prior art.

For example, the controller 10 can be inserted at a flanged connection 22 by disconnecting the flanges 21a, 21b from each other and then either: displacing one flange 21a relative to the other 21b, laterally or axially, or temporarily removing one flange 21a and an associated section of line 20 or a spool (not shown). Furthermore, by mounting the valve 30 substantially on one side of the plate 12, insertion of the controller 10 is facilitated. More particularly, insertion of the controller 10 is facilitated by such mounting of the valve 30 when the flanges 21a, 21b are displaced laterally relative to each other.

### Pressure Control Valve—One Embodiment:

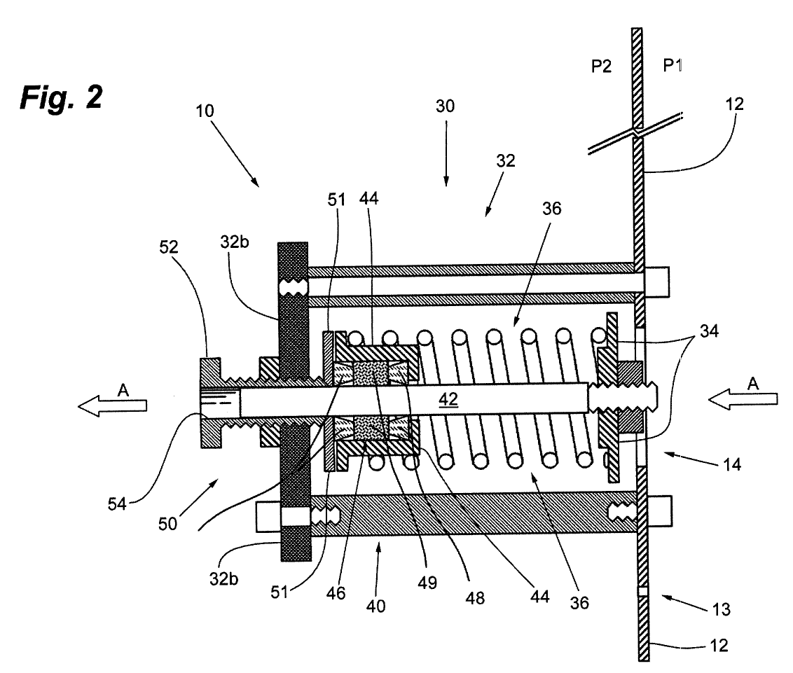

With reference to FIG. 2, a preferred embodiment of the pressure control valve 30 is shown mounted on a flange-supported plate 12 having a port 14. The pressure control valve 30 comprises a cage 32 having a backing plate 32b, a moveable disc 34 and a spring 36. The cage 32 is supported from the flange-supported plate 12 and extends downstream terminating with the backing plate 32b. The disc 34 engages the plate 12 on the downstream side P2 and is suitable to block the port 14. The flange-supported plate 12, disc 34 and backing plate 32b all reside in the same plane. The spring 36 is compressively sandwiched between the backing plate 32b and the disc 34 for normally biasing the disc 34 against the flange-supported plate 12 so as to seal the port 14.

Generally, and with reference to both FIGS. 1 and 2, when the controller 10 is inserted into a flow line 20, a pressure differential is created P1, P2. The pressure differential P1, P2 exerts a force on the disc 34 in the direction of the flow A. The spring 36 exerts an opposing force on the disc 34, biasing the disc 34 against the plate 12 and sealing the port 14. When the force of the pressure differential P1, P2 exceeds the force exerted by the spring 36, the spring 36 compresses, the disc 34 moves downstream and gas flows in direction A. When equilibrium is reached between the opposing forces, of the pressure differential P1, P2 and the spring 36, a desired pressure differential P1, P2 is created in the gas flow line 20. Advantageously, by controlling the flow A through the port 14 with the pressure control valve 30, a pressure differential P1, P2 results the magnitude of which is less sensitive to variations in flow than is one created by an orifice plate.

Referring again to FIG. 2, the pressure control valve 30 of the preferred embodiment further comprises vibration dampening means 40 to reducing vibration of the disc 34 during operation. The dampening means 40 includes a guide rod 42 and a bearing retainer or housing 44 having friction means 46. The guide rod 42 is perpendicularly attached to the disc 34 and extends axially through the spring 36 and the housing 44 and is engaged by the friction means 46. More particularly, the guide rod 42 is moveably supported in the cage 32 in a reciprocating action for variably positioning the disc 34 relative to the port 14.

During operation, the friction means 46 dampen the axial movement of the rod 42 relative to the cage 32 thereby reducing vibration of the disc 34. The friction means 46 can be one or more packings, seals or bearings 48. Additional stability is preferably provided using two or more bearings 48 which can also be axially spaced by an annular polytetrafluoroethylene (PTFE) spacer 49. The bearings 49 are preferably PTFE, stainless steel loaded, annular lip seals such as those having model number CNC R19TCG91901 by Hi-Tech Seals of Edmonton, Alberta, Canada.

Preferably, for adjusting the preload in the spring 36, the valve 30 further comprises preload adjustment means 50. In this embodiment, and as part of the preload adjustment means 50, the housing 44 is adjustably movable relative to the backing plate 32b and the spring 36 is supported between the disc 34 and the housing 44. The preload adjustment means 50 further comprises an adjuster washer 51 positioned between the housing 44 and the backing plate 32b. The adjuster washer 51 is axially adjustable using a jacking bolt 52, which is operable relative to the backing plate 32b. Preferably, the jacking bolt 52 has a bore 54 for guiding the guide rod 42.

The materials of construction for the controller 10 can be 304 Stainless Steel (SS) for sweet gas operations but are preferably 316 SS for sour (H₂S) operations and all operations for minimizing manufacturing stock. The spring 36 can be 320 SS for sweet and Inconel for sour operations. The plate 12 material is typical for orifice plates in the same industry, being ⅛″ 316L SS. Similarly it is understood that larger lines require larger, thicker plates 12.

Although one embodiment of a pressure control valve 30 has been described above, other embodiments are equally suitable as long as they are sized so as to reside wholly within the gas flow line 20 and are mounted on, or supported by, the flange-supported plate 12 so as to properly seal the port 14 or ports. In fact, a great variety of pressure control valves are well known in the art.

### EXAMPLES:

For 2″ flow line, flanged operations, a plate having a ¾″ diameter port is fitted with a disc loaded by a 36 lb. spring which provides a 15-25 psi differential pressure. A 3″ flange-mounted controller uses a 40 lb. spring, while a 4″ flange-mounted controller uses a 60 lb. spring. The spring can be respecified or doubled up for achieving higher differential pressures.

### Controller Placement:

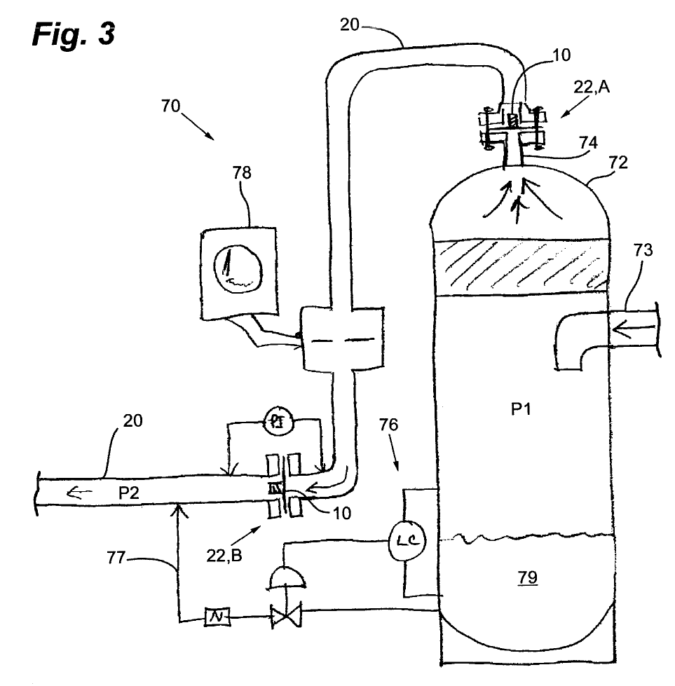

With reference to FIG. 3, a conventional pressurized wellhead separator system 70 is shown to illustrate various alternate placement options for the controller 10 so as to create a pressure differential from a high pressure P1 to a lower pressure P2. The separator system 70 includes a pressurized well inlet separator 72 having an inlet 73 and outlet 74, a discharge gas flow line 20, a liquid level control system 76 with dump line 77 and a gas flow meter 78.

Typically in operation, a mixed stream of gas and liquid enters the separator 72 via the inlet 73. The liquid falls out to the bottom of the separator 72 and collects as a condensate 79, while the gas exits the separator 72 via the outlet 74. The level control system 76 causes the condensate 79 to periodically be blown down to the flow line 20, downstream of the flow meter 78 through the dump line 77.

To allow the level control system 76 to function properly, the dump line 77 connects to the gas flow line 20 downstream of the controller 10; i.e. at the lower pressure P2. As such, the controller 10 may be inserted into the flow line 20 at any point upstream of the dump line 77. For example, the controller 10 can be inserted in the flanged connection 22 at position A; between the outlet 74 and gas meter 78. More preferably, the controller 10 is inserted in the flanged connection 22 at position B; between the gas meter 78 and dump line 77 results in consistent backpressure of the gas meter 78.

In one example of a wellhead separator system 70 with the level control system 76 functioning properly, the higher pressure P1 may be 820 psig, the low pressure may be 800 psig. The controller 10 is therefore creating a pressure differential of 20 psig. The differential pressure controller 10 of the present invention can be set for variable pressure differential at a variety of operating pressures by using the preload adjusting means 60 as illustrated in FIG. 2. For example, in a 2″ flange embodiment, the controller is typically set for a 10-25 psi differential (psid). Accordingly, a sufficiently lower pressure line P₂ is assured, resulting in reliable dumping of produced condensate 79 into the flow line 20.

### Controller Use and Operation:

More specifically, in a gas-separating operation and referring to FIGS. 2 and 3, gas flows from the top of the separator 72 through the meter 78 and then through the controller 10 placed at the preferred position B. It can take a pressure difference between 10 to 25 psid to overcome the spring 36 and permit gas to flow through the controller 10. When on-line at normal operating condition, the separator 72 is maintained at 10-25 psig above line pressure P2 of a downstream system (not shown) connected to the flow line 20. Whenever the condensate level controller 76 calls for a dump of accumulated liquid, and with the maintained pressure differential, consistent dumping occurs. Therefore optimum measurement by the gas meter 78 is possible due to this repeatable proven setup and operation.

This controller 10 replaces considerably more expensive equipment and requires little maintenance. As the controller 10 is installed between existing flanges, no additional pipework is required.

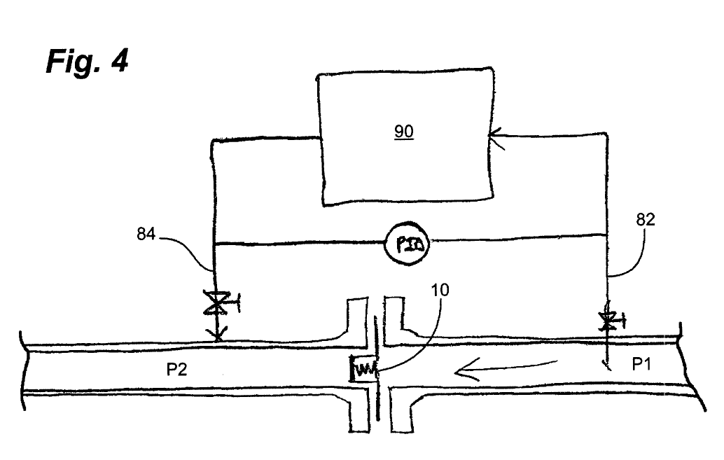

Now referring to FIG. 4, the controller 10 can also be used for inducing a sufficient differential pressure P1, P2 to produce a sample stream for a chromatograph, moisture analyzer or other analyzer 90. The sample from the line 20 enters the analyzer 90 from a sample point 82 upstream of the controller 10 (at the higher pressure P1) and returns to the line 20 at a point downstream of the controller 10 (at the lower pressure P2).

### Advantages:

Advantages of the differential pressure controller include: quiet operation; long life—vibration in the disc in a gas stream being virtually non-existent, with spring failure and disc/plate interfaces being saved from peening failure; adaptable to various line sizes; no instrument air or fuel gas required and environmentally safe; no sensing lines to freeze, plug off, or fail; no costly bellows to fail; no soft parts subject to failure; virtually no welding modifications required to retrofit; not subject to tampering which would affect factors including: the back pressure, turbine gas meter measurements or flooding of an attached separator due to loss of back pressure control; and not as sensitive to hydrate problems as are the -more complicated valve control systems.

While the invention has been described with reference to several preferred embodiments, it is to be clearly understood by those skilled in the art that the invention is not limited thereto. Rather, the scope of the invention is to be interpreted only in conjunction with the appended claims.

THE EMBODIMENTS OF THE INVENTION IN WHICH AN EXCLUSIVE PROPERTY OR PRIVILEGE IS BEING CLAIMED ARE DEFINED AS FOLLOWS:

1. A differential pressure controller for placement in a gas flow line having a flanged connection, comprising:
a plate adapted for insertion into the line and supported at the flanged connection,
at least one flow port formed through said plate; and
at least one pressure control valve mounted on the plate, said valve residing wholly within the gas flow line and adapted to control flow through the flow port;
wherein said plate is of such dimensions so as to direct substantially all of the line's gas flow through the flow port and pressure control valve, thereby creating a pressure differential in the gas flow line.

2. The differential pressure controller of claim 1 wherein the pressure control valve is mounted substantially on one side of the plate.

3. The differential pressure controller of claim 2 wherein the pressure control valve further comprises:
a cage supported from the plate and having a backing plate;
a disc for variably blocking the flow port thereby controlling gas flow; and
a spring for normally biasing the disc to seal the flow port, the spring being compressed positioned between the disc and the backing plate for loading the disc.

4. The differential pressure controller of claim 3 wherein the pressure control valve further comprises vibration dampening means.

5. The differential pressure controller of claim 4 wherein the vibration dampening means comprises:
a housing supported from the cage;
a guide rod perpendicularly attached to the disc and extending axially through the housing; and
friction means supported in the housing and engaging the guide rod,
wherein the friction means restrict the axial movement of the rod relative to the cage.

6. The differential pressure controller of claim 5 wherein the pressure control valve further comprises preload adjustment means.

7. The differential pressure controller of claim 6 wherein the spring is supported between the disc and the housing, and the preload adjustment means further comprises:
an adjuster washer positioned between the housing and the backing plate; and
a jacking bolt operable relative to the backing plate,
wherein the adjuster washer is axially adjustable using the jacking bolt.

8. The differential pressure controller of claim 7 wherein the jacking bolt has a bore for guiding the guide rod.

9. The differential pressure controller of claim 8 wherein the plate has a liquid drain hole to allow liquid to bleed across the plate.

10. The differential pressure controller of claim 3 wherein the pressure control valve further comprises preload adjustment means.

11. The differential pressure controller of claim 10 wherein the spring is supported between the disc and the housing, and the preload adjustment means further comprises:
an adjuster washer positioned between the housing and the backing plate; and
a jacking bolt operable relative to the backing plate,
wherein the adjuster washer is axially adjustable using the jacking bolt.

12. The differential pressure controller of claim 11 wherein the jacking bolt has a bore for guiding the guide rod.

13. A system for developing a pressure differential in pressurized wellhead separator having a well inlet separator, a gas flow line, a gas meter and a liquid level control with a dump line downstream of the gas meter, the system comprising:
a flanged connection in the gas flow line -downstream of the well inlet separator and upstream of the dump line; and
a differential pressure controller inserted into the gas flow line at the flanged connection, the controller comprising:
a plate adapted for insertion into the line and supported at the flanged connection,
at least one flow port formed through said plate; and
at least one pressure control valve mounted on the plate, said valve residing wholly within the gas flow line and adapted to control flow through the flow port;
wherein said plate is of such dimensions so as to direct substantially all of the line's gas flow through the flow port and pressure control valve, thereby creating a pressure differential in the gas flow line.

14. The system of claim 13 wherein the gas meter is upstream of the flanged connection.

15. A system for developing a pressure differential in a gas flow line comprising:
at least one flanged connection in the gas flow line; and
a differential pressure controller inserted into the gas flow line at the flanged connection, the controller comprising:
a plate adapted for insertion into the line and supported at the flanged connection,
at least one flow port formed through said plate; and
at least one pressure control valve mounted on the plate, said valve residing wholly within the gas flow line and adapted to control flow through the flow port;
wherein said plate is of such dimensions so as to direct substantially all of the line's gas flow through the flow port and pressure control valve, thereby creating a pressure differential in the gas flow line.

16. The differential pressure controller of claim 15 wherein the pressure control valve is mounted substantially on one side of the plate.

17. The differential pressure controller of claim 16 wherein the pressure control valve further comprises:
a cage supported from the plate and having a backing plate;
a disc for variably blocking the flow port thereby controlling gas flow; and
a spring for normally biasing the disc lo seal the flow port, the spring being compressed positioned between the disc and the backing plate for loading the disc.

18. The differential pressure controller of claim 17 wherein the pressure control valve further comprises:
a housing supported from the cage;
a guide rod perpendicularly attached to the disc and extending axially through the housing; and
friction means supported in the housing and engaging the guide rod,
wherein the friction means restrict the axial movement of the rod relative to the cage.

19. The differential pressure controller of claim 18 wherein the pressure control valve further comprises:
an adjuster washer positioned between the housing and the backing plate; and
a jacking bolt operable relative to the backing plate,
wherein the adjuster washer is axially adjustable using the jacking bolt.
